(19) United States
(12) Patent Application Publication
(10) Pub. No.: US 2008/0086779 A1
(43) Pub. Date: Apr. 10, 2008

(54) System and method for digital rights management with license proxy

(75) Inventors: Curtis Blake, Fair Oaks, CA (US); Robert Kellogg, Purcellville, VA (US); Robert Bernardi, Bethesda, MD (US)

Correspondence Address: Benman, Brown & Williams, Suite 2740, 2049 Century Park East, Los Angeles, CA, 90067, US

(73) Assignee: GigaMedia Access Corporation

(21) Appl. No.: 11/542,766

(22) Filed: Oct. 4, 2006

(51) Int. Cl. H04L 9/32; H04L 9/00; G06F 17/30; G06F 7/04; G06K 9/00; H04K 1/00; H03M 1/68; H04N 7/16

(52) U.S. Cl. 726/27; 705/51; 705/59; 713/173

(57) ABSTRACT

A digital rights management system and method. The inventive system includes a client for publishing and/or viewing protected content; a DRM server for providing licenses for viewing the protected content; and an inventive license proxy server coupled between the client and the server. The license proxy server includes a digital rights management lockbox and plural digital rights management client certificates. The license proxy server is disposed on an operationally independent platform relative to the client or the DRM server and thereby extends a DRM vendor's rights management capabilities to other platforms.

### BACKGROUND OF THE INVENTION

1. Field of the Invention

The present invention relates to computing and communications systems. More specifically, the present invention relates to systems and methods for providing for secure communications between computing platforms via a communications network.

2. Description of the Related Art

For many modern enterprises, information that is produced and consumed exists in digital form (e.g., electronic mail messages, word processing documents, spreadsheets, and databases). This digital content or data is often a valuable asset that requires protection and security. Indeed, most current and valuable enterprise information is captured in digital documents. Computers have become essential tools for processing and managing this ever-growing stockpile of information. However, enterprises are particularly challenged to protect this growing amount of valuable digital data against deliberate disclosure or accidental mishandling. For this purpose, Digital Rights Management (DRM) techniques have been employed.

As discussed in “Digital Rights Management”, DRM is any of several technologies used by publishers to control access to digital data (such as software, music, movies) and hardware. (See Wikipedia, Digital Rights Management, http://en.wikipedia.ore/wiki/Digital Rights Management (as of Jul. 18, 2006, 02:37 GMT)). In more technical terms, DRM handles the description, layering, analysis, valuation, trading, monitoring and enforcement of usage restrictions that accompany a specific instance of a digital work.

Conventionally, DRM is implemented with a number of components distributed between a Rights Management Server and a vendor-specific client platform supported by the DRM vendor. Rights-managed documents and email messages are referred to throughout this document as ‘Protected Content’. When Protected Content is published, the publisher specifies which individuals can access the Protected Content as well as what kind of access rights are granted to those individuals. Individuals to whom access rights are granted are referred to herein as ‘Principals’. Access rights determine, for example, whether the Principal can only view the information, or whether the Principal can also perform other operations such as printing, editing, or saving the information.

A ‘Secure Publisher’ is a software module that is primarily responsible for protecting content. ‘Secure Viewer’ refers to the software module that is responsible for presenting the protected content to a Principal, while enforcing access rights that potentially limit what the Principal can do with the content. The Secure Publisher protects the content by encrypting it, and then sealing the decryption key along with the Principals and their access rights, in a ‘Publishing License’. The Secure Viewer uses the Publishing License to decrypt the content and enforce access rights. The secure viewing mechanism is key, because DRM is about enforcing access rights, without surrendering control of the information to the recipient of a document or email.

The Secure Publisher initializes the DRM lockbox that verifies that the publisher is signed by a trusted DRM authority and that the signature is valid. This ensures to the DRM lockbox that the publisher has not been tampered with. The DRM lockbox creates an empty publishing license. The DRM lockbox randomly generates a symmetric key used for Advanced Encryption Standard (AES) encryption. The DRM lockbox encrypts the symmetric key with the server's public key using the Rivest, Shamir, Adelman (RSA) public key algorithm.

The DRM lockbox returns the publishing license to the Secure Publisher along with an End User License (EUL). The Secure Publisher binds the EUL to the user's Rights-management Account Certificate (RAC), using the DRM Lockbox, resulting in an encryption handle. The Secure Publisher provides the encryption handle to the DRM Lockbox along with the unencrypted content. The DRM Lockbox encrypts the content using AES encryption and the symmetric key. The Secure Publisher then publishes the encrypted content along with the publishing license.

A Secure Viewer then initializes the DRM lockbox which verifies that the viewer is signed by a trusted DRM authority and that the signature is valid, thereby ensuring to the DRM lockbox that the viewer has not been tampered with. A secure viewer obtains an End User License for protected content by sending the content's Publishing License to a DRM server, along with the user's RSA public key.

The DRM server authenticates the user and uses the server's RSA private key to unseal the symmetric AES key in the Publishing License. The DRM server uses the AES symmetric key to unseal the encrypted principals and rights information in the publishing license. If rights have been granted to the requesting user, then the DRM server creates an End User License by encrypting the AES symmetric key using the user's RSA public key. The Secure Viewer binds the EUL to the user's RAC, using the DRM Lockbox, resulting in a decryption handle. The Secure Viewer provides the decryption handle to the DRM Lockbox along with the encrypted content. The DRM Lockbox decrypts the content using AES encryption and the 16-byte symmetric key. The DRM Lockbox returns the decrypted content to the Secure Viewer. The Secure Viewer enforces access rights as specified in the End User License.

Although effective, the above-described technology lacks platform independence. DRM servers tend to be platform independent web services, but will generally only interoperate with their own proprietary rights management client components, which are tied to the hardware and operating system platform that the DRM vendor chooses to support.

Hence, a need remains in the art for a system or method for providing DRM for client hardware and operating system platforms beyond those supported by a DRM vendor.

### SUMMARY OF THE INVENTION

The need in the art is addressed by the digital rights management system and method of the present invention. The inventive system includes a client for publishing and/or viewing protected content; a server for providing licenses for viewing the protected content; and an inventive license proxy server coupled between the client and the server.

In the illustrative embodiment, the server is a DRM server and the license proxy server includes a digital rights management lockbox and plural digital rights management client certificates. The license proxy server is disposed on an operationally independent platform relative to the client and thereby extends a DRM vendor's rights management capabilities to other platforms.

### BRIEF DESCRIPTION OF THE DRAWINGS

FIG. 1 is a simplified block diagram showing a digital rights management scheme implemented in accordance with conventional teachings.

FIG. 2 is a flow diagram which illustrates secure publishing in accordance with the conventional digital rights management scheme of FIG. 1.

FIG. 3 is a flow diagram which illustrates secure viewing in accordance with the conventional digital rights management scheme of FIGS. 1 and 2.

FIG. 4 is a simplified block diagram showing a digital rights management scheme implemented with a License Proxy Server in accordance with the digital rights management scheme of the present invention.

FIG. 5 is a flow diagram which illustrates secure publishing in accordance with the digital rights management scheme of the present invention.

FIG. 6 is a flow diagram which illustrates secure viewing in accordance with the digital rights management scheme of the present invention.

### DESCRIPTION OF THE INVENTION

Illustrative embodiments and exemplary applications will now be described with reference to the accompanying drawings to disclose the advantageous teachings of the present invention.

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

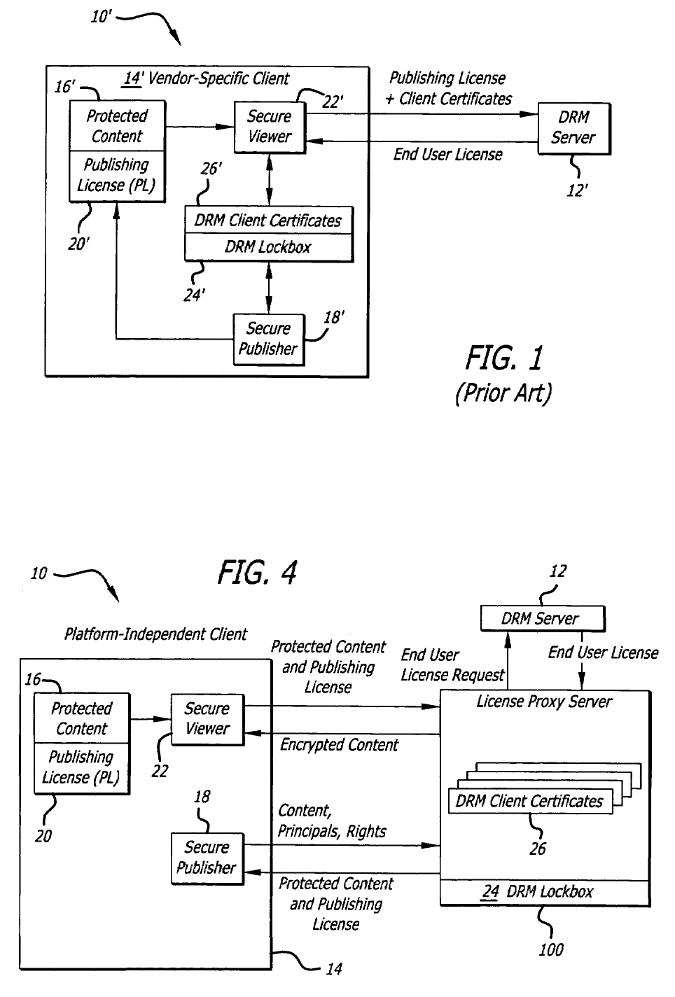

FIG. 1 is a simplified block diagram showing a digital rights management scheme implemented in accordance with conventional teachings. As shown in FIG. 1, the conventional digital rights management system 10′ consisted of a number of components distributed between a Rights Management Server 12′ and a vendor-specific client platform 14′ supported by a DRM vendor.

As used herein:
‘Protected Content’ refers to rights-managed documents and email messages;
‘Principals’ refers to individuals to whom access rights are granted in or to Protected Content;
‘Access Rights’ control for example whether the Principal can only view the information, or whether the Principal can also perform other operations such as printing, editing, or saving the information;
‘Secure Publisher’ refers to a software module that is primarily responsible for protecting content;
‘Secure Viewer’ refers to a software module that is responsible for presenting the protected content to a Principal, while enforcing access rights that potentially limit what the Principal can do with the content;
‘Publishing License’ refers to a file that contains a decryption key, Principals and the access rights thereof; and
‘DRM’ Lockbox refers to the scheme commonly used in existing DRM solutions that prevents an authorized user from gaining access to the decryption keys or the decrypted content outside of the Secure Viewer or Secure Publisher.

In accordance with conventional teachings, when Protected Content 16′ is published, the publisher specifies which individuals can access the Protected Content as well as the access rights that are granted to those individuals. A Secure Publisher 18′ protects the content by encrypting it and then sealing the decryption key along with the Principals and their access rights, in a Publishing License 20′. A Secure Viewer 22′ uses the Publishing License to decrypt the content and enforce access rights. The secure viewing mechanism is of critical importance, because the purpose of Digital Rights Management is to enforce access rights at all times, without even momentarily surrendering control of the information to the recipient of a document or email.

The steps involved in publishing and viewing Protected Content will now be considered.

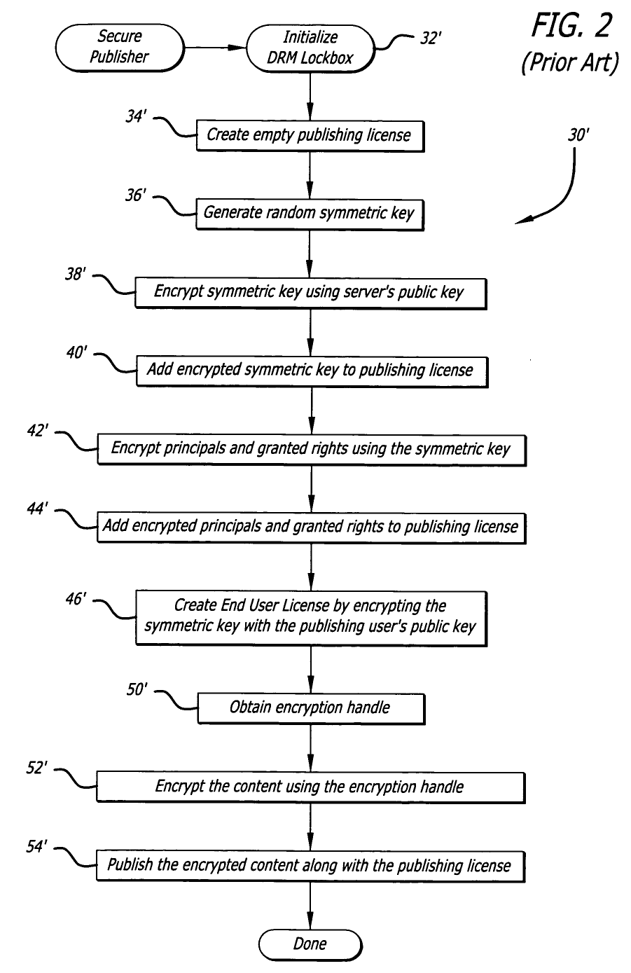

FIG. 2 is a flow diagram which illustrates secure publishing in accordance with the conventional digital rights management scheme of FIG. 1. As illustrated in FIG. 2, at step 32′, a Secure Publisher 18′ (FIG. 1) initializes a DRM lockbox 24′ (FIG. 1) which verifies that the publisher is signed by a trusted DRM authority and that the signature is valid. This ensures to the DRM lockbox 24′ that the publisher 18′ (FIG. 1) has not been tampered with. At step 34′, the DRM lockbox creates an empty publishing license. Next, at step 36′, the DRM lockbox randomly generates a 16 byte symmetric key used for Advanced Encryption Standard (AES) encryption. At step 38′, the DRM lockbox encrypts the 16 byte (128 bits) symmetric key with the server's public key using the RSA public key algorithm. The length of the server's public key is typically 1024 bits.

At step 40′ the encrypted symmetric key is added to the publishing license and at step 42′ the principals and access rights are encrypted. Next, at step 44′, the principals and access rights are added to the publishing license. At step 46′, an end user license is created by encrypting the symmetric key with the publishing user's public key.

Then, at step 50′, the DRM lockbox returns the publishing license to the Secure Publisher along with an End User License (EUL). The Secure Publisher binds the EUL to the user's RAC, using the DRM Lockbox, resulting in an encryption handle. At step 52′, the Secure Publisher provides the encryption handle to the DRM Lockbox along with the unencrypted content. The DRM Lockbox encrypts the content using AES encryption and the 16 byte symmetric key. Finally, at step 54′, the Secure Publisher publishes the encrypted content along with the publishing license. Noted. Comments are included above under “Brief Description of Drawings”.

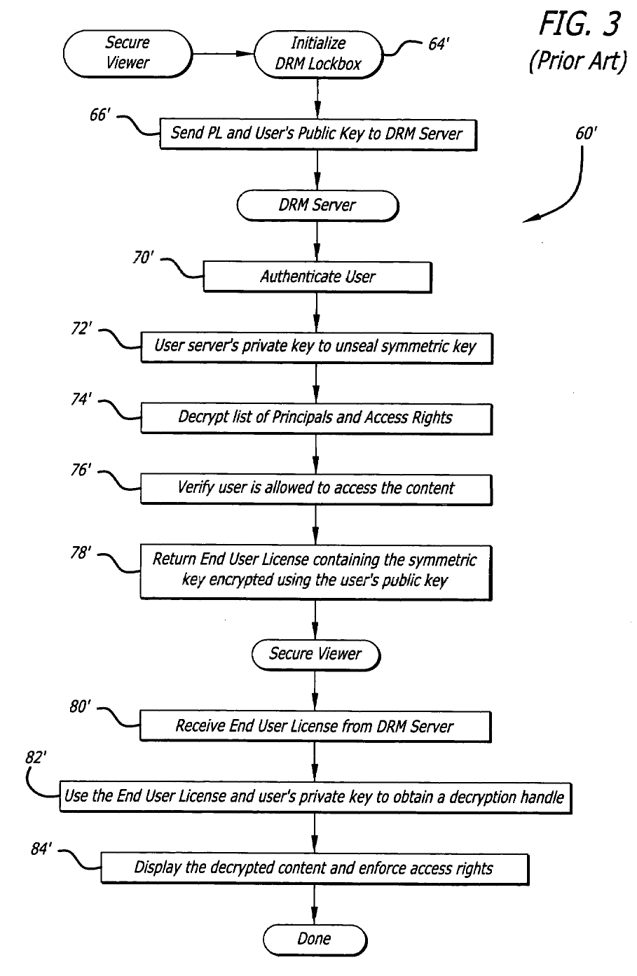

FIG. 3 is a flow diagram which illustrates secure viewing in accordance with the conventional digital rights management scheme of FIGS. 1 and 2. At step 64′, the Secure Viewer 22′ (FIG. 1) initializes the DRM lockbox 18′ (FIG. 1) which verifies that the viewer is signed by a trusted DRM authority and that the signature is valid, thereby ensuring to the DRM lockbox that the viewer has not been tampered with. As shown in FIG. 3, the secure viewer obtains an End User License for protected content by first sending the content's Publishing License to a DRM server, along with the user's RSA 1024-bit public key at step 66′. At steps 70′ and 72′, the DRM server authenticates the user and uses the server's 1024-bit RSA private key to unseal the symmetric AES key in the Publishing License. Then, at step 74′, the DRM server uses the AES symmetric key to unseal the encrypted principals and rights information in the publishing license. If, at step 76′, the system determines that rights have been granted to the requesting user, then, at step 78′, the DRM server returns an End User License by encrypting the AES symmetric key using the user's RSA 1024-bit public key. At step 80′, the viewer receives the End User License from the DRM server and at step 82′, the Secure Viewer binds the EUL to the user's Rights-management Account Certificate (RAC), using the DRM Lockbox, resulting in a decryption handle. The Secure Viewer provides the decryption handle to the DRM Lockbox along with the encrypted content. The DRM Lockbox decrypts the content using AES decryption and the 16-byte symmetric key. The DRM Lockbox returns the decrypted content to the Secure Viewer. The Secure Viewer enforces access rights as specified in the End User License allowing the user to display the decrypted content.

Unfortunately, the conventional scheme described above lacks platform independence. That is, although DRM servers tend to be platform independent web services, they apparently currently only interoperate with their own proprietary rights management client components, which are tied to the hardware and operating system platform that the DRM vendor chooses to support.

Hence, there is a need in the art for a system or method for expanding high performance Digital Rights Management offerings such as GigaTrust to client hardware and operating system platforms beyond the ones supported by a single DRM vendor. In accordance with the present invention, a License Proxy Server is implemented, along with additional rights management client components, that extend a DRM vendor's rights management capabilities to other platforms. The inventive license proxy server, referred to herein as the ‘GigaTrust License Proxy Server’, is discussed more fully below.

FIG. 4 is a simplified block diagram showing a digital rights management scheme implemented with a License Proxy Server in accordance with the present teachings. The GigaTrust License Proxy Server 100 supports a platform-independent client 14, first by hosting the DRM vendor's platform specific components (i.e., a DRM lockbox 24 and client certificates 26) on the License Proxy Server 100 and then by implementing and exposing a platform-independent web service interface to the License Proxy Server. The GigaTrust License Proxy solution also includes client-side Secure Publisher and Secure Viewer components 18 and 22 respectively, that may be platform-dependent or platform-independent, and that communicate with the GigaTrust License Proxy Server 100 via a platform-independent web service. The term “web service” is used loosely here, and can refer to any of a number of inter-computer communication mechanisms that would allow information to flow between computer systems.

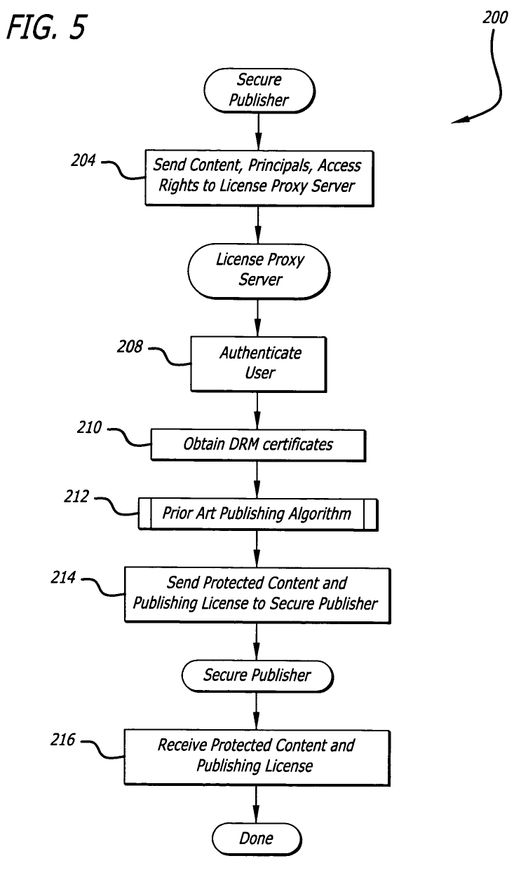

FIG. 5 is a flow diagram which illustrates secure publishing in accordance with the digital rights management scheme of the present invention. At step 204, a Secure Publisher running on any client platform sends the unprotected content, along with a list of Principals and the access rights to be granted to those Principals, to the License Proxy Server. Next, at step 208, the License Proxy Server authenticates the user, and determines whether it has the necessary DRM certificates for the user as required by the DRM Server. If necessary, at step 210, the License Proxy Server authenticates to the DRM Server and obtains DRM certificates on behalf of the end user, that is, on behalf of the user running the Secure Publisher on the client. At step 212, the License Proxy Server protects the content in a manner similar to that described above with respect to FIG. 2, with the License Proxy Server acting as the Vendor-Specific Client as far as the DRM Server is concerned.

At step 214, the License Proxy Server sends the Protected Content along with the Publishing License to the Secure Publisher. The request from the Secure Publisher to the License Proxy Server may be synchronous or asynchronous, and so the Protected Content and Publishing License may be returned to the Secure Publisher in response to the original request, or it may be forwarded to the Secure Publisher later after the original request has terminated.

Finally, at step 216, the Secure Publisher receives the Protected Content and the Publishing License from the License Proxy Server.

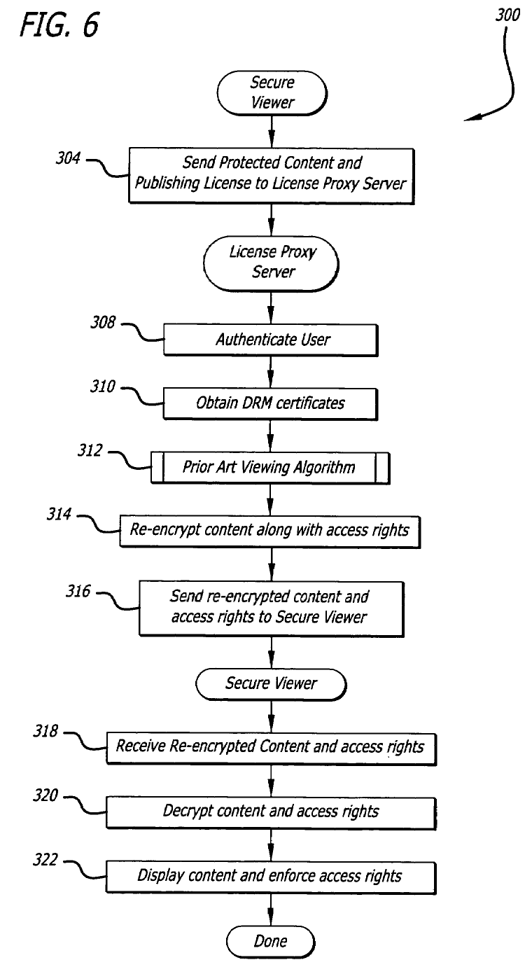

FIG. 6 is a flow diagram which illustrates secure viewing in accordance with the digital rights management scheme of the present invention. The Secure Viewer consists of a variety of mechanisms, with a common characteristic that they set a high bar for securing content against malicious threats, comparable to the standard of security that exists conventionally for DRM solutions that utilize a DRM lockbox on the client. As shown in FIG. 6, at step 304, a Secure Viewer running on any client platform sends the Protected Content, along with its Publishing License, to the License Proxy Server. At step 308, the License Proxy Server authenticates the user, and determines whether it has the necessary DRM certificates for the user as required by the DRM Server. If necessary, at step 310, the License Proxy Server authenticates to the DRM Server and obtains DRM certificates on behalf of the end user, in other words, on behalf of the user running the Secure Viewer on the client. At step 312, the License Proxy Server decrypts the content in a manner similar to that described under Prior Art Viewing Algorithm, with the License Proxy Server acting as the Vendor-Specific Client as far as the DRM Server is concerned. At steps 314 and 316, the License Proxy Server re-encrypts the content along with a list of access rights, and sends the re-encrypted content and access rights to the Secure Viewer. At steps 318, 320 and 322, the Secure Viewer receives the encrypted content and access rights, decrypts the content and access rights, displays the decrypted content and enforces access rights in accordance with the publishing license.

Those skilled in the art will appreciate that the processes depicted in the flow diagrams shown and described herein may be implemented in software, using C++, Java, C#, or other suitable language, stored on a machine readable physical storage medium and adapted for execution by a processor or general purpose digital computer.

Thus, the present invention has been described herein with reference to a particular embodiment for a particular application. Those having ordinary skill in the art and access to the present teachings will recognize additional modifications, applications and embodiments within the scope thereof. For example,

It is therefore intended by the appended claims to cover any and all such applications, modifications and embodiments within the scope of the present invention.

Accordingly,

What is claimed is:

1. A digital rights management system comprising:
client means for publishing and/or viewing protected content;
server means for providing licenses for viewing said protected content; and
a license proxy server coupled between said client means and said server means.

2. The invention of claim 1 wherein said license proxy server includes a lockbox.

3. The invention of claim 2 wherein said lockbox is a digital rights management lockbox.

4. The invention of claim 1 wherein said license proxy server includes a client certificate.

5. The invention of claim 4 wherein said certificate is a digital rights management client certificate.

6. The invention of claim 5 wherein said license proxy server includes plural digital rights management client certificates.

7. The invention of claim 1 wherein said server is a digital rights management server.

8. The invention of claim 1 wherein said license proxy server is disposed on a separate physical platform relative to said client means or said server means.

9. The invention of claim 8 wherein said license proxy server is disposed on a separate physical platform relative to said client means and said server means.

10. The invention of claim 1 wherein said license proxy server is disposed on an operationally independent platform relative to said client means or said server means.

11. The invention of claim 10 wherein said license proxy server is disposed on an operationally independent platform relative to said client means and said server means.

12. A digital rights management system comprising:
a platform independent client for publishing and/or viewing protected content;
a digital rights management server for providing a license for viewing said protected content; and
a license proxy server coupled between said client and said digital rights management server.

13. The invention of claim 1 wherein said license proxy server includes a lockbox.

14. The invention of claim 13 wherein said lockbox is a digital rights management lockbox.

15. The invention of claim 14 wherein said license proxy server includes plural digital rights management client certificates.

16. The invention of claim 12 wherein said license proxy server includes a client certificate.

17. The invention of claim 16 wherein said certificate is a digital rights management client certificate.

18. The invention of claim 17 wherein said license proxy server includes plural digital rights management client certificates.

19. The invention of claim 18 further including a digital rights management lockbox.

20. The invention of claim 12 wherein said license proxy server is disposed on a separate physical platform relative to said client means or said server means.

21. The invention of claim 20 wherein said license proxy server is disposed on a separate physical platform relative to said client means and said server means.

22. The invention of claim 12 wherein said license proxy server is disposed on an operationally independent platform relative to said client means or said server means.

23. The invention of claim 22 wherein said license proxy server is disposed on an operationally independent platform relative to said client means and said server means.

24. A license proxy server for use with client for publishing and/or viewing protected content and a digital rights management server for providing licenses for viewing said protected content, said license proxy server being operationally disposed between said client and said rights management server and comprising:
means for providing a lockbox and
means for storing at least one client certificate.

25. The invention of claim 24 wherein said lockbox is a digital rights management lockbox.

26. The invention of claim 24 including means for storing plural client certificates.

27. The invention of claim 26 wherein said certificates are digital rights management certificates.

28. A license proxy server for use with client for publishing and/or viewing protected content and a digital rights management server for providing licenses for viewing said protected content, said license proxy server being operationally disposed between said client and said rights management server and comprising:
a controller adapted to execute software and
software stored on a physical medium readable by said controller, said software including code for providing a lockbox and code for storing at least one client certificate.

29. The invention of claim 28 wherein said lockbox is a digital rights management lockbox.

30. The invention of claim 28 including means for storing plural client certificates.

31. The invention of claim 30 wherein said certificates are digital rights management certificates.

32. A method for digital rights management including the steps of:
providing a client for publishing and/or viewing protected content;
providing a server for providing licenses for viewing said protected content; and
using a license proxy server as an interface between said client and said server.

33. The invention of claim 32 further including the step of providing a lockbox in said license proxy server.

34. The invention of claim 33 wherein said lockbox is a digital rights management lockbox.

35. The invention of claim 32 further including the step of providing a client certificate in said license proxy server.

36. The invention of claim 35 wherein said certificate is a digital rights management client certificate.

37. The invention of claim 36 wherein said license proxy server includes plural digital rights management client certificates.

38. The invention of claim 33 wherein said server is a digital rights management server.

39. The invention of claim 33 further including the step of disposing said license proxy server on a separate physical platform relative to said client or said server.

40. The invention of claim 39 further including the step of disposing said license proxy server on a separate physical platform relative to said client and said server.

41. The invention of claim 33 further including the step of disposing said license proxy server on an operationally independent platform relative to said client or said server.

42. The invention of claim 41 further including the step of disposing said license proxy server on an operationally independent platform relative to said client and said server.
